(19) United States
(12) Patent Application Publication
(10) Pub. No.: US 2013/0081778 A1
(43) Pub. Date: Apr. 4, 2013

(54) METHOD AND APPARATUS FOR A CLOSE-COUPLED COOLING SYSTEM

(71) Applicants: Scott A. Good, Mesa, AZ (US); Simon R. Rohrich, Chandler, AZ (US); William E. Woodbury, II, Gilbert, AZ (US)

(72) Inventors: Scott A. Good, Mesa, AZ (US); Simon R. Rohrich, Chandler, AZ (US); William E. Woodbury, II, Gilbert, AZ (US)

(73) Assignee: ELLIPTICAL MOBILE SOLUTIONS, LLC., Chandler, AZ (US)

(21) Appl. No.: 13/251,511

(22) Filed: Oct. 3, 2011

(51) Int. Cl. F28F 27/00; G05D 23/00; F28D 15/00

(52) U.S. Cl. 165/11.1; 165/104.19; 165/104.13; 165/287

(57) ABSTRACT

A method and apparatus for a close-coupled cooling system provides an equipment rack that includes at least one heat exchanger in close proximity to electrical components contained within the equipment rack. The heat exchanger receives inlet water at a selected temperature to adjust a cooling capacity of the heat exchanger to maintain an adequate cooling capacity of the heat exchanger to reject heat generated within the equipment rack. Exhaust water from the heat exchanger may be cooled by a heat rejection source, blended with cooled water from a heat rejection source, and/or blended with cooled water from the heat rejection source and a chiller to achieve the desired inlet water temperature to the heat exchanger. A substantially zero-bypass, differential pressure air-flow system may be used in conjunction with the heat exchanger to further adjust a cooling capacity of the heat exchanger.

### FIELD OF THE INVENTION

The present invention generally relates to data centers, and more particularly to data centers that employ close-coupled cooling for each electronic enclosure within the data center.

### BACKGROUND

All electrical equipment produces heat when operated within design parameters established for the electrical equipment. In order to prevent damage, the heat produced by the electrical equipment, as well as heat that may be generated by other heat sources in proximity to the electrical equipment, must at least be partially removed to prevent the temperature of the electrical equipment from exceeding the electrical equipment manufacturer's recommended temperature levels.

Conventional techniques employed within an equipment room (e.g., an information technology (IT) data center) to cool the electrical equipment within such an equipment room utilizes air that is pre-cooled and distributed within the equipment room to remove at least a portion of the heat that is generated within the equipment room. The pre-cooled air is caused to flow over the electrical equipment, thereby causing heat to be transferred from the electrical equipment to the pre-cooled air, which causes the pre-cooled air to increase in temperature. The heated air is then re-conditioned (e.g., cooled again) and recirculated within the equipment room.

The total heat generated within an equipment room may be calculated as the sum of heat output from each of the heat-producing components that are contained within the equipment room. Accordingly, not only the electrical equipment, but also the uninterruptible power supplies, power distribution, lighting, air conditioning units, and equipment room support staff, to mention only a few heat sources, contribute to the total heat that may be generated within an equipment room.

Air distributed within an equipment room is typically distributed using computer room air conditioners/air handlers (CRACs/CRAHs) that may chill the air down to a specific temperature range between approximately 60 deg F. to 80 deg F. (e.g., approximately 72 deg F.) to satisfy the cooling demands of the electrical equipment within the equipment room. The chilled air is caused to flow over the electrical equipment so that heat may be extracted from the electrical equipment and absorbed by the chilled air. Air heated by the electrical equipment may then be exhausted from the equipment room to a heat rejection source (e.g., a remote condenser or chiller).

The temperature of the chilled air is often cooled below the cooling demands of the electrical equipment within the equipment room to allow for the absorption of heat from the other heat contributors within the equipment room. Accordingly, cooling efficiencies of traditional CRAC/CRAH systems are typically very low (e.g., 30%), since cooled air provided by the CRAC/CRAH systems often travels many hundreds of feet before it actually comes into contact with the electrical equipment. That is to say, in other words, that a very low percentage (e.g., 30%) of the energy used to cool electrical equipment within an equipment room may actually be used to cool the electrical equipment, while the remaining larger percentage of energy (e.g., 70%) may be wasted on the other heat contributors within the equipment room.

Accordingly, air is often cooled well below the temperature range required by the electrical equipment. For example, a typical design requirement for the temperature of supply air provided by a conventional CRAC/CRAH system may be 45-55 deg F., so that by the time the cooled air arrives at the electrical equipment, it may exhibit a temperature (e.g., 72 deg F.) that is sufficient to cool the electrical equipment to within a specified temperature range. In so doing, precious energy may be wasted when super-cooling supply air so as to account for the inefficiencies of a conventional CRAC/CRAH system.

A conventional CRAC/CRAH system may distribute chilled water to heat exchangers, or coils, in air handling units which cool the air in their respective spaces. The cooling coils are used to transfer heat from the air to the chilled water, thereby cooling the air stream as well as dehumidifying the air stream. In order to supply sufficiently cooled air (e.g., air cooled to 72 deg F.) to the electrical equipment, however, chilled water ranging from 35 deg F. to 45 deg F. is typically required by the heat exchangers.

Supplying super-cooled air to an equipment room environment, therefore, represents inefficiencies in energy usage that can no longer be tolerated by today's green movement. Efforts continue, therefore, to establish high-efficiency cooling methods and systems that far exceed the energy-usage efficiencies of traditional CRAC/CRAH systems.

### SUMMARY

To overcome limitations in the prior art, and to overcome other limitations that will become apparent upon reading and understanding the present specification, various embodiments of the present invention disclose systems and methods for providing close-coupled cooling. Certain of the close-coupled cooling characteristics may include eliminating altogether the need to provide separate condensers and/or chillers when distributing cooled air to electrical equipment within an equipment room.

In accordance with one embodiment of the invention, a close-coupled cooling system comprises an equipment rack that includes a heat exchanger. The close-coupled cooling system further comprises a water supply to provide water into the heat exchanger. A temperature of the water is adjusted to select a cooling capacity of the heat exchanger.

In accordance with another embodiment of the invention, a cooling system comprises an equipment rack, a heat exchanger included within the equipment rack, and a controller. The controller selects a temperature of water flow into the heat exchanger to adjust a cooling capacity of the heat exchanger that is below a maximum cooling capacity of the heat exchanger.

In accordance with another embodiment of the invention, a method comprises selecting a desired cooling capacity of a heat exchanger, selecting a water inlet temperature to the heat exchanger, and adjusting a cooling capacity of the heat exchanger to the desired cooling capacity in response to the selected water inlet temperature.

### BRIEF DESCRIPTION OF THE DRAWINGS

Various aspects and advantages of the invention will become apparent upon review of the following detailed description and upon reference to the drawings in which:

FIG. 1 illustrates an exemplary close-coupled cooling system;

FIG. 2 illustrates exemplary air and water flows within an exemplary close-coupled cooling system;

FIG. 3 illustrates an exemplary heat exchanger;

FIG. 4 illustrates a graph plotting exemplary inlet water temperature versus cooling capacity;

FIG. 5 illustrates an exemplary plan view of an equipment enclosure; and

FIG. 6 illustrates exemplary process flow charts.

### DETAILED DESCRIPTION

Generally, the various embodiments of the present invention are applied to close-coupled cooling systems that implement localized heat exchangers. A close-coupled cooling system may, for example, provide localized heat-exchangers such that a one-to-one correspondence may exist between a particular heat exchanger and a particular equipment rack that houses an arrangement of equipment that is to be cooled by the heat exchanger.

In one embodiment, for example, equipment may be arranged in a high-density fashion within a single equipment rack, such that a single heat-exchanger may be utilized to extract heat away from the high-density arrangement. In an alternate embodiment, equipment may be arranged in a high-density fashion within a single equipment rack, such that dual heat exchangers may be utilized to extract heat away from the high-density arrangement. It should be noted, that more than two heat exchangers may be used in a single equipment rack. In so doing, one or more heat exchangers may be localized to provide close-coupled cooling such that relatively small distances (e.g., a few inches) may exist between the equipment to be cooled and the heat exchanger(s) used to cool the equipment.

Close-coupled cooling may allow for high-efficiency cooling, since a substantial portion of the energy used to extract heat from the electrical equipment may be utilized to cool the electrical equipment. High efficiencies may be achieved, for example, due to the placement of heat exchangers within a close proximity to the electrical equipment being cooled. Accordingly, a minimization of the distance between the heat exchanger and the electrical equipment being cooled minimizes the possibility that cooled air is used for purposes other than to pull heat away from the electrical equipment.

The capacity of the heat exchangers used within the cooling system may be substantially diminished while at the same time maintaining an adequate level of cooling within each equipment rack. For example, a water-based heat exchanger exhibiting a high cooling capacity (e.g., 40 kW of cooling capacity) may be reduced to less than half of the maximum cooling capacity (e.g., less than 20 kW of cooling capacity) while at the same time maintaining an adequate cooling level within the equipment rack. Cooling capacity may be further reduced to approximately one-third (e.g., reduced from 40 kW maximum capacity to approximately 13 kW capacity) while simultaneously providing adequate cooling within the equipment rack.

The inlet water temperature of the water-based heat exchanger may be increased to reducing the cooling capacity of the heat exchanger to significantly diminished, yet adequate, levels. Accordingly, the cold air supply within an equipment rack may be maintained at acceptable temperatures by the heat exchanger notwithstanding the diminished cooling capacity of the heat exchanger.

Non-condenser-based heat rejection sources (e.g., evaporation-based heat rejection sources) may be utilized when increased inlet water temperatures of water-based heat exchangers may be tolerated. In one embodiment, for example, water chillers may be replaced with evaporation cooling (or some other form of radiation-based cooling) to significantly reduce an amount of energy that may be required to cool the inlet water supplied to a water-based heat exchanger.

For example, water chillers producing water inlet temperatures of approximately 45 deg F. may be replaced with, for example, evaporation-based or radiation-based cooling systems, such that inlet water exhibiting higher temperatures ranging between approximately 75 and 95 deg F. (e.g., approximately 85 deg F.) may be used as the inlet water to a water-based heat exchanger. Despite using the higher temperature water, adequate cooling within each equipment rack may nevertheless be achieved. In so doing, higher temperature inlet water may be pumped into high-capacity heat exchangers, thereby reducing the capacity of the heat exchangers, but nevertheless maintaining the capacity of the heat exchangers to meet the cooling requirements of the electrical equipment within each equipment rack. Accordingly, high-capacity heat exchangers may be used in a close-coupled cooling arrangement within each equipment rack to adequately cool the electrical equipment within each equipment rack, while at the same time obviating the need to use water chillers at all.

Close-coupled cooling arrangements utilizing increased inlet water temperatures may significantly increase power usage effectiveness (PUE), where PUE is a measure of how efficiently a data center uses its power. In particular, PUE is the ratio of the total amount of power used by the equipment room (e.g., data center) to the power delivered to the computing equipment in the equipment room. For example, utilizing a heat exchanger at full capacity by first chilling the inlet water temperatures to specified levels may achieve a PUE ratio of approximately 1.2, which is to say that for every unit of energy consumed by the electrical equipment, 0.2 units of energy are used for other purposes (e.g., energy used by the chiller equipment and lighting within the data center). As per another example, utilizing a high-capacity heat exchanger at reduced capacity through the use of non-chilled inlet water temperatures may achieve a significantly reduced PUE (e.g., a PUE of approximately 1.05), since the energy required to cool the electrical equipment may be significantly reduced through the elimination of the need for the water chiller.

By utilizing one or more high-efficiency heat exchangers per equipment rack in a close-coupled arrangement, an amount of heat that may be rejected from each rack may be selected based upon a temperature of the inlet water introduced to the one or more heat exchangers. For example, a 40 kW heat exchanger may be selected to remove approximately 13 kW of heat from an equipment rack by selecting the appropriate inlet water temperature (e.g., 85 deg F.) into the heat exchanger. Accordingly, for example, an approximate two-thirds reduction (e.g., a reduction from approximately 40 kW to approximately 13 kW) in capacity may result due to the increased inlet water temperature, but the one-third capacity (e.g., 13 kW) of cooling capacity that remains may nevertheless be adequate cooling for most applications. As per another example, an inlet water temperature may be selected to 85 deg F. to achieve 26 kW of heat rejection when, for example, two 40 kW heat exchangers are used for a single equipment rack in a close-coupled arrangement. Accordingly, increased inlet water temperatures may reduce the capacity of high-capacity heat exchangers, but may nevertheless produce adequate cooling for high-density (e.g., greater than 10 kW of electrical equipment load) applications. Even higher capacity heat exchanger(s) (e.g., 80 kW heat exchangers) may be utilized as well. It should be noted that lower capacity heat exchangers (e.g., lower than 40 kW such as 10 kW or 20 kW) heat exchangers may be used as well.

Any arrangement may be used to adjust the requisite inlet water temperature to the heat exchanger. For example, an evaporative arrangement (e.g., a cooling tower) or thermal radiation arrangement may be used for cooling of exhaust water that may have been generated through operation of heat exchangers that may be operating within one or more equipment racks. In colder climates, for example, a cooling tower may cool the inlet water temperature too much. Accordingly, for example, heated exhaust water may be blended with cooled water from a cooling tower to adjust (e.g., increase) the inlet water temperature to a required temperature. In warmer climates, for example, chillers may be utilized, when needed, to supplement the cooling performance of a cooling tower so that requisite inlet water temperatures may be adjusted (e.g., inlet water temperatures may be decreased).

Air flow within each equipment rack may be selected as a closed-loop air flow. Accordingly, for example, a heat exchanger may include one or more variable-speed fans that may direct cooled air toward a particular portion of the equipment rack (e.g., the front portion of the equipment rack). The cooled air may, for example, be drawn into each electrical component contained within the equipment rack by fans situated within each electrical component.

As per another example, the one or more fans of the one or more heat exchangers may create a differential pressure within each equipment rack, such that a greater volume of cooled air may be presented to the cooled-air intake of each electrical component within the equipment rack than may be consumed by each electrical component within the equipment rack. Accordingly, a greater air pressure may exist at the cooled-air inlet to each electrical component than may exist at the heated-air exhaust from each electrical component. In so doing, the differential pressure system created by closed-loop air flow within each equipment rack may generate enough air flow through the electrical components, such that the need for fans to be situated within each of the electrical components may be obviated. By removing the need for fans from the electrical components within the equipment rack due to closed-loop pressurized air flow, a magnitude of power consumption by each electrical component may be reduced, thereby reducing an amount of cooling that may be required for each electrical component.

Pressure sensors may be installed within each equipment rack to, for example, monitor a volume of air that may be available to flow into the electrical components within each equipment rack. The pressure measurements generated by the pressure sensors may, for example, be used in a feedback arrangement to adjust a speed at which one or more variable-speed fans of the one or more heat exchangers may be operating. Accordingly, a variable, positive pressure may be maintained in a dynamic fashion, such that a programmable air flow volume may be maintained within each electrical component of the equipment rack. Other sensors (e.g., temperature sensors) may also be used in a feedback arrangement to dynamically control a temperature of the air flow within the equipment rack. Temperature sensors may, for example, provide feedback to a blending valve controller to raise or lower the temperature of the inlet water to a heat exchanger, which may operate to raise or lower the temperature of the air flow within the equipment rack.

It is understood that one or more controllers may receive the feedback signals from the pressure sensor(s), temperature sensor(s), and any other sensors, meters, and/or control valves that may be in operation. Accordingly, the one or more controllers may control one or more operating parameters associated with the cooling system (e.g., air flow rate and/or air flow temperature within the one or more equipment racks, water flow rate and/or water flow temperature into the one or more heat exchangers of the one or more equipment racks, and water flow rate and/or water flow temperature exhausted from the one or more heat exchangers of the one or more equipment racks).

Two heat exchangers may, for example, be utilized within a single equipment rack in a dual-redundancy mode. A volume and temperature of air generated by a single heat exchanger may, for example, be adequate to reject the heat load generated by the electrical equipment within the equipment rack. Accordingly, for example, the one or more fans of the dual heat exchangers may be dynamically adjusted to maintain a positive pressure system within the equipment rack, such that the dual heat exchangers may combine to reject heat generated by the electrical equipment within the equipment rack. A failure of one of the heat exchangers may be detected and automatically compensated by increasing a capacity of the remaining heat exchanger to produce a fully redundant, closed-loop cooling system within the equipment rack.

Sealing mechanisms may, for example, be used within the equipment rack so as to insure that a substantial portion of the cooled air is provided only to the air intake of each electrical component within the equipment rack. Accordingly, a substantially zero-bypass arrangement may be achieved, such that virtually all of the cooled air generated within the equipment rack by the one or more heat exchangers may be consumed by the electrical components within the equipment rack and virtually none of the cooled air may be allowed to escape the air intake of each electrical component within the equipment rack. In so doing, for example, sealing brushes and blanking plates may be used to insure that substantially all of the cooled air generated by the heat exchanger(s) may be available for consumption by the electrical components within the equipment rack. In addition, sealing brushes and blanking plates may be used to insure an adequate pressure differential within the equipment rack.

A zero-bypass, pressurized air flow system within an equipment rack may increase the capacity of each heat exchanger implemented within the equipment rack. Accordingly, a heat exchanger whose capacity is significantly reduced from a maximum capacity (e.g., reduced below 50% of maximum capacity) by increasing the water inlet temperature to the heat exchanger may regain a portion of the capacity lost. Due to a substantially zero-bypass, pressurized air flow system that may be maintained within the equipment rack, the reduced capacity of the heat exchanger may be significantly increased (e.g., increased by approximately 10-40%) notwithstanding the increased inlet water temperature. In so doing, for example, a 20 kW heat exchanger operating at reduced capacity (e.g., 35% capacity at approximately 7 kW) with 85 deg F. inlet water temperature may increase its capacity (e.g., increase to 52.5% capacity at approximately 10.5 kW) with 85 deg F. inlet water temperature when a substantially zero-bypass, pressurized air flow system is used in conjunction with the heat exchanger within the equipment rack.

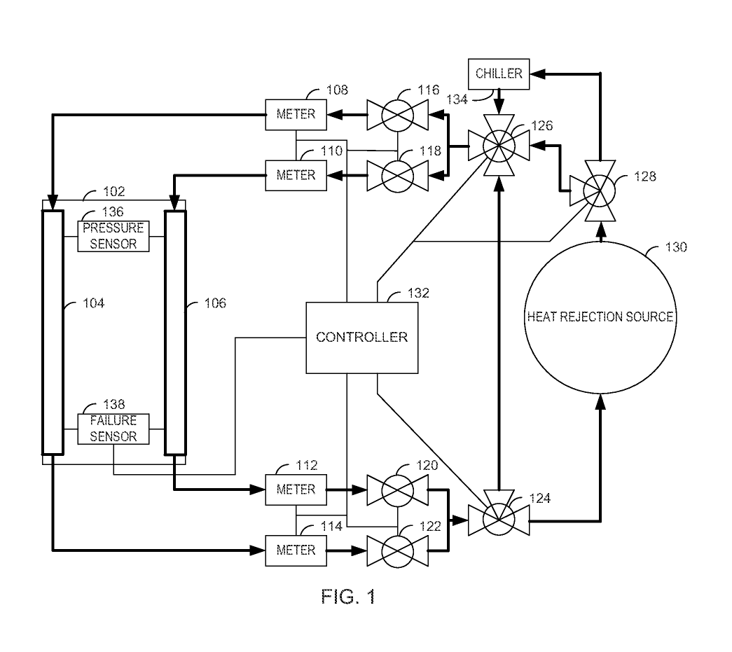

Turning to FIG. 1, a cooling system is exemplified, which may include equipment rack 102, heat exchanger 104, optional heat exchanger 106, water flow and/or water temperature meters 108-114, water flow valves 116-128, heat rejection source 130, chiller 134, pressure sensor 136 and failure sensor 138. In operation, the cooling system of FIG. 1 monitors and adjusts the inlet water temperature provided by a water supply to heat exchanger(s) 104 and/or 106 so that the cooling capacity of heat exchanger(s) 104 and/or 106 may be controlled. That is to say, for example, that meter(s) 108 and/or 110 may monitor the inlet water flow and/or temperature into heat exchangers 104 and/or 106, respectively. In response, controller 132 may control the operation of water flow valves 120-128 to obtain the requisite inlet water temperature to heat exchanger(s) 104 and/or 106 so as to control the cooling capacity of heat exchanger(s) 104 and/or 106. In addition, controller 132 may monitor the cooling performance of heat exchangers 104 and/or 106 by, for example, by monitoring the temperature of water being exhausted from heat exchanger(s) 104 and/or 106 via meter(s) 114 and/or 112, respectively. Controller 132 may, for example, monitor the air temperature within equipment rack 102 to determine the cooling performance of heat exchanger(s) 104 and/or 106.

Heat exchanger 104 may, for example, exhibit a maximum cooling capacity (e.g., 40 kW) when the inlet water temperature to heat exchanger 104 is at a corresponding minimum temperature (e.g., 55 deg F.). The cooling capacity of heat exchanger 104 may, for example, be significantly reduced by increasing the inlet water temperature to heat exchanger 104. Accordingly, for example, heat exchanger 104 may exhibit a reduced cooling capacity (e.g., approximately 33% of maximum capacity at approximately 13 kW) when the corresponding inlet water temperature is at a corresponding temperature (e.g., 85 deg F.). In so doing, for example, controller 132 may dynamically increase an inlet water temperature to heat exchanger 104 that corresponds to a reduced cooling capacity that may be adequate to cool electrical equipment that may be operating within equipment rack 102. Cooling capacity may, for example, be selected in response to an amount of heat being generated within equipment rack 104 (e.g., an amount of heat being generated by an IT load contained within equipment rack 102) and/or a desired air temperature that may be required within equipment rack 102.

Similarly, optional heat exchanger 106 may exhibit a maximum cooling capacity (e.g., 40 kW) when the inlet water temperature to heat exchanger 106 is at a corresponding minimum temperature (e.g., 55 deg F.). The cooling capacity of heat exchanger 106 may, for example, be significantly reduced by increasing the inlet water temperature to heat exchanger 106. Accordingly, for example, heat exchanger 106 may exhibit a reduced cooling capacity (e.g., approximately 33% of maximum capacity at approximately 13 kW) when the corresponding inlet water temperature is at a corresponding temperature (e.g., 85 deg F.). In so doing, for example, controller 132 may dynamically select an inlet water temperature to heat exchanger 106 that corresponds to a cooling capacity that may be required given an amount of heat being generated within equipment rack 104 and/or a temperature of air that may be required within equipment rack 104. It is understood that heat exchanger 106 may be operating in a dual-redundant capacity to heat exchanger 104, such that either heat exchanger or both heat exchangers may operate to provide the requisite cooling within equipment rack 102.

Utilizing heat exchanger 104 and optional heat exchanger 106 within equipment rack 102 may, for example, yield a combined cooling capacity (e.g., 26 kW), when the inlet water temperature to heat exchangers 104 and 106 is at a corresponding temperature (e.g., 85 deg F.). Accordingly, for example, heat exchangers 104 and 106 may be used in combination to reject an amount of heat that may be generated by all of the electronic equipment that may be operating within equipment rack 102.

For example, given that an IT load contained within equipment rack 102 generates 10 kW of heat, controller 132 may dynamically increase an inlet water temperature to heat exchangers 104 and 106, such that the combined cooling capacity of heat exchangers 104 and 106 is reduced to approximately 10 kW. Accordingly, for example, an inlet water temperature to heat exchangers 104 and 106 may be selected to control the cooling capacity of heat exchangers 104 and 106.

In one embodiment, controller 132 may monitor the temperature of the outlet water via meters 112 and 114 to compute the amount of heat being rejected from equipment rack 102. If, for example, an amount of heat being rejected from equipment rack 102 is less than an amount of heat being generated by an IT load contained within equipment rack 102, then controller 132 may lower the inlet water temperature to heat exchangers 104 and/or 106, thereby increasing the overall cooling capacity of heat exchangers 104 and/or 106. If, for example, an amount of heat being rejected from equipment rack 102 is more than an amount of heat being generated by an IT load contained within equipment rack 102, then controller 132 may increase the inlet water temperature to heat exchangers 104 and/or 106, thereby decreasing the overall cooling capacity of heat exchangers 104 and/or 106. In so doing, for example, the cooling capacity of heat exchangers 104 and/or 106 may be optimized to the IT load that may be contained within equipment rack 102. In alternate embodiments, a temperature of air flowing within equipment rack 102 may be monitored by controller 132 so as to determine whether the cooling capacity of heat exchangers 104 and/or 106 is sufficient. In response, controller 132 may adjust the inlet water temperature to heat exchangers 104 and/or 106 accordingly.

Heat exchangers 104 and 106 may be utilized as redundant cooling systems within equipment rack 102. For example, failure sensor 138 may detect a failure within either of heat exchanger 104 or 106 and may report the failure to controller 132. In response, controller 132 may stop the flow of inlet water into the failed heat exchanger by closing the corresponding flow valve (e.g., flow valve 116 or 118). In addition, controller 132 may decrease the inlet water temperature to the operational heat exchanger and/or increase the air flow from the operational heat exchanger, so that the cooling capacity of the operational heat exchanger may be increased. Accordingly, for example, the cooling capacity of the operational heat exchanger may be increased to compensate for the loss in cooling capacity resulting from the failed heat exchanger.

It is understood that operation of controller 132 may be distributed among two or more controllers within the cooling system of FIG. 1. For example, a heat exchanger controller (not shown) may control water flow valves 116 and 118, pressure sensor 136, failure sensor 138, and a fan speed of variable-speed fans (not shown) within heat exchangers 104 and/or 106. Accordingly, for example, in response to a measurement of the inlet air temperature (e.g., the cooled air temperature) within equipment rack 102, the heat exchanger controller (not shown) may regulate the inlet air temperature by controlling the volume of water flow into heat exchangers 104 and/or 106 and/or the volume of air flow generated by heat exchangers 104 and/or 106.

Further distribution of controller 132 operation may, for example, include a heat rejection controller (not shown) that may, for example, maintain the water inlet temperature to heat exchangers 104 and/or 106. For example, the heat rejection controller (not shown) may control flow valves 120-128 to control the inlet water temperature to heat exchangers 104 and/or 106 by blending water from different sources (e.g., water from heat rejection source 130, exhaust water from heat exchangers 104 and/or 106, and water from optional chiller 134). The heat rejection controller (not shown) may, for example, control the operation of heat rejection source 130 to increase or decrease the temperature of water provided by heat rejection source 130.

The inlet water temperature to heat exchangers 104 and/or 106 may be adjusted through appropriate control of, for example, flow valves 120-128. If, for example, the water temperature generated by heat rejection source 130 is below a desired inlet water temperature, then at least a portion of heated water exhausted from heat exchangers 104 and/or 106 via flow valves 122 and/or 120 may be directed to flow valve 126 via flow valve 124. In so doing, for example, at least a portion of heated water may bypass heat rejection source 130 to be blended with cooled water from heat rejection source 130 via flow valve 126 to raise the temperature of water flowing into flow valves 116 and/or 118. Accordingly, the inlet water temperature flowing into heat exchangers 104 and/or 106 may be raised, thereby decreasing the cooling capacity of heat exchangers 104 and/or 106.

If, for example, the water temperature generated by heat rejection source 130 is above a desired inlet water temperature, then cooled water from heat rejection source 130 may be directed to chiller 134 via flow valve 128. In so doing, for example, at least a portion of cooled water from heat rejection source 130 may be directed to chiller 134 via flow valve 128 and blended with at least a portion of water from heat rejection source 130 via flow valve 126 to lower the temperature of water flowing into flow valves 116 and/or 118. Accordingly, the inlet water temperature flowing into heat exchangers 104 and/or 106 may be lowered, thereby increasing the cooling capacity of heat exchangers 104 and/or 106.

In one embodiment, water flow into heat rejection source 130 may be bypassed altogether by directing exhaust water from flow valve 124 to flow valve 126. That is to say, for example, that heat rejected (e.g., rejected via radiated heat) may be adequate to lower the inlet water temperature flowing into heat exchangers 104 and/or 106 by an amount adequate to select the cooling capacity required from heat exchangers 104 and/or 106. In such an instance, the energy used by heat rejection source 130 (and optionally chiller 134) may be conserved to further decrease the PUE that may be achieved by the cooling system of FIG. 1.

Heat exchangers 104 and/or 106 may be equipped with one or more variable speed fans (not shown) to control a volume of air flow within equipment rack 102. In addition, a differential pressure system may be invoked within equipment rack 102, such that the volume of air generated by the variable-speed fans (not shown) may exceed the volume of air that may be consumed by the electronic equipment within equipment rack 102. Accordingly, one or more pressure sensors 136 may be utilized within equipment rack 102 to measure the pressure differential. A heat exchanger controller (not shown) may, for example, receive a signal from pressure sensor 136 and in response, may control the volume of air generated by the variable-speed fans (not shown) so as to maintain a nominal pressure differential (e.g., a slightly greater air pressure at the intake of the electrical components contained within equipment rack 102 as compared to the pressure of air exhausted by the electrical components contained within equipment rack 102). In so doing, for example, a signal from the heat exchanger controller (not shown) may be provided to variable-speed fans (not shown) within heat exchangers 104 and/or 106 so as to dynamically select a variable pressure differential regardless of a volume of air that may be required by the electronic equipment contained within equipment rack 102.

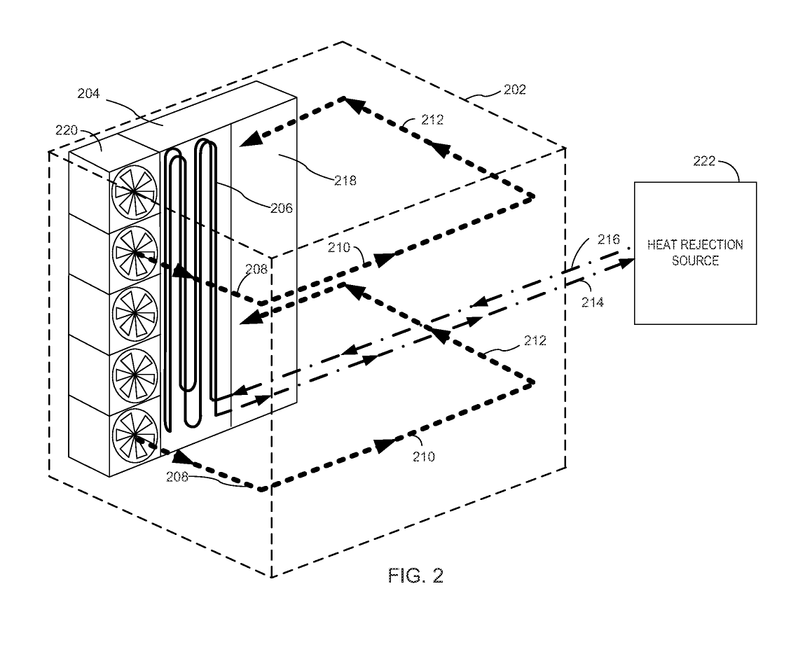

Turning to FIG. 2, air and water flow within a cooling system is exemplified. The cooling system of FIG. 2 may include one or more equipment racks 202, heat exchanger 204, and heat rejection source 222. It is understood that equipment rack 202 may include two or more heat exchangers. It is further understood that heat rejection source 206 may include any combination of chillers, cooling towers, heat radiation devices, blenders, controllers, and water flow valves that may be required to produce outlet water flow 216 having a configurable water temperature that may be selected below, equal to, or above the water temperature of inlet water flow 214. Accordingly, for example, regardless of a water temperature of inlet water flow 214, a water temperature of outlet water flow 216 may be selectable to any temperature that may be required to achieve a requisite cooling capacity of heat exchanger 204. In so doing, a controller (not shown) may select a water temperature of outlet water flow 216 that may be required to adjust a cooling capacity of heat exchanger 204 that may be adequate to reject an amount of heat that may be generated by electronic equipment (not shown) that may exist within equipment rack 202. In addition, a controller (not shown) may select a speed at which one or more fans 220 may be operating, so that a volume of heated air entering air inlet 218 of heat exchanger 204 may be adjusted to further adjust a cooling capacity of heat exchanger 204.

In operation, heat exchanger 204 may include a set of coils 206 that may receive outlet water flow 216. Coils 206 may, for example, be made of a material (e.g., a metal such as copper) that may facilitate a transfer of heat from air that flows around coils 206 to water that flows within coils 206. For example, as outlet water flow 216 flows through coils 206, heated air flow 212 may be caused to flow over coils 206, thereby transferring heat from heated air flow 212 to coils 206, which may cause the temperature of water flowing within coils 206 to increase, thereby causing heated air flow 212 to become cooled air flow 208. Circulation of air flows 208, 210, and 212 may be caused by one or more variable-speed fans 220 of heat exchanger 204, such that cooled air flow 210 may be received by electronic components (not shown) within equipment rack 202. As cooled air flow 210 removes heat from the electronic components (not shown) within equipment rack 202, cooled air flow 210 becomes heated air flow 212, which may then be rerouted through heat exchanger 204 to be reconditioned into cooled airflow 208. It can be seen, for example, that air flow generated within equipment rack 202 may be circulated within a closed-loop system (i.e., no air external to equipment rack 202 is introduced into equipment rack 202 during operation of the electrical components contained within equipment rack 202).

Pressure sensors (not shown) within equipment rack 202 may sense a pressure differential between cooled air flow 208 and heated air flow 212. For example, a pressure differential may be created by a greater volume of cooled air flow 208 being generated than may be exhausted by the electronic components (not shown) within equipment rack 202 as heated air flow 212. Such a pressure differential may, for example, be sensed and a speed of the one or more variable-speed fans 218 of heat exchanger 204 may be increased, decreased, or left unchanged depending upon the sensed pressure differential. In so doing, for example, a variable, positive pressure differential may be maintained within equipment rack 202 so as to insure that an ample volume of cooled air flow 208 exists to remove heat being generated by electronic equipment (not shown) that may be contained within equipment rack 202. In addition, a portion of any reduction in the capacity of heat exchanger 204 due to an increase in inlet water temperature 216 may be regained through an increase in a volume of air flow that may be generated by increasing the speed at which one or more fans 220 may be operating.

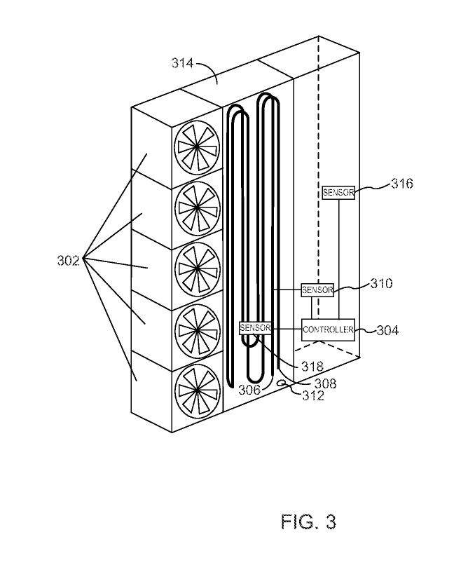

Turning to FIG. 3, a heat exchanger is exemplified, which may include one or more variable-speed fans 302, controller 304, water inlet 306, water outlet 308, water inlet temperature sensor 310, condensation drain 312, air/water heat exchanger 314, air inlet temperature sensor 316, air exhaust temperature sensor 318, and a droplet separator (not shown).

Controller 304 may, for example, control a speed of one or more fans 302, in response to a feedback signal from a pressure sensor (not shown), which may be used to control a volume of air that may be provided by one or more fans 302. For example, if the pressure sensor indicates a higher pressure than desired, controller 304 may reduce a speed of one or more fans 302. Alternately, for example, if the pressure sensor indicates a lower pressure than desired, controller 304 may increase a speed of one or more fans 302.

Any condensation that may be formed within air/water heat exchanger 314 may be expelled by condensation drain 312, so that water from condensation may not be allowed to make contact with electronic components that may be in close proximity to air/water heat exchanger 314. A droplet separator (not shown) may further be used, for example, to protect electronic components that may be in close proximity to air/water heat exchanger 314 from moisture (e.g., a droplet separator may shield electronic components from water generated by a ruptured coil within air/water heat exchanger 314).

Water inlet temperature sensor 310 may, for example, provide a temperature signal to controller 304, which may send a signal to a heat rejection controller (not shown) to adjust (e.g., increase or decrease) a water temperature and/or a water flow rate of inlet water that may flow into air/water heat exchanger 314 via water inlet 306. Alternately, for example, air exhaust temperature sensor 318 may send a signal to controller 304 to adjust (e.g., increase or decrease) a speed of one or more fans 302 based upon a temperature of cooled air being generated by air/water heat exchanger 314. In so doing, for example, a cooling capacity of the heat exchanger of FIG. 3 may be adjusted by controlling a water temperature and/or a water flow rate of inlet water to air/water heat exchanger 314 and/or controlling a volume of air generated by one or more fans 302.

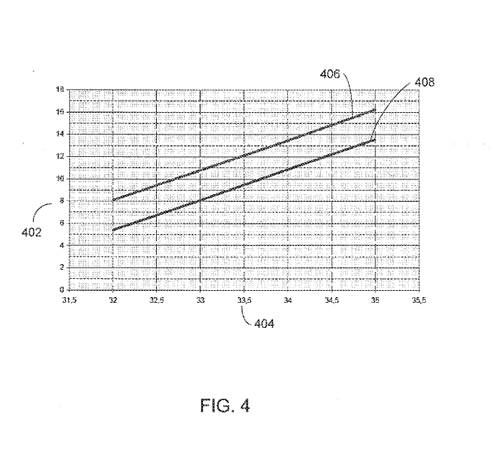

Turning to FIG. 4, for example, a graph depicting exemplary cooling capacities 402 of a heat exchanger exhibiting a maximum cooling capacity (e.g., 40 kW) against increased inlet water temperatures is exemplified. In particular, for example, cooling capacities are plotted against inlet water temperatures that exceed a water temperature that may be necessary to obtain the maximum 40 kW cooling capacity from the heat exchanger. Graph 406, for example, plots cooling capacity in kW for an inlet water temperature of approximately 29 deg C. (or approximately 84.2 deg F.) against desired cooled air temperatures 404 that may exist within an equipment rack employing such a heat exchanger. Graph 408, for example, plots cooling capacity in kW for an inlet water temperature of approximately 30 deg C. (or approximately 86 deg F.) against cooled air temperatures 404.

As can be seen, for example, cooling capacities of heat exchangers may be significantly reduced by adjusting the water inlet temperatures to such heat exchangers. In addition, for example, by adjusting the water inlet temperatures, the cooling capacities may be adjusted to obtain a desired cool air supply temperature within an equipment rack that may employ such a capacity-reduced heat exchanger.

For example, as plot 406 exemplifies, a 40 kW heat exchanger may exhibit approximately 8 kW of cooling capacity while maintaining a cold air supply temperature within an equipment rack at 32 deg C. by adjusting an inlet water temperature to the heat exchanger to approximately 84.2 deg F. Alternately, for example, a 40 kW heat exchanger may virtually double its cooling capacity (e.g., approximately 16 kW) if the cold air supply temperature within an equipment rack is allowed to increase to 35 deg C. using the same inlet water temperature.

As per another example, as plot 408 exemplifies, a 40 kW heat exchanger may exhibit approximately 5.4 kW of cooling capacity while maintaining a cold air supply temperature within an equipment rack at 32 deg C. by adjusting an inlet water temperature of the heat exchanger to approximately 86 deg F. Alternately, for example, a 40 kW heat exchanger may increase its cooling capacity (e.g., to approximately 13.5 kW) if the cold air supply temperature within an equipment rack is allowed to increase to 35 deg C. using the same inlet water temperature to the heat exchanger.

The cooling capacities of the heat exchangers plotted in FIG. 4 may be increased by utilizing a substantially zero-bypass, pressurized air flow system in conjunction with the heat exchanger within the equipment rack. The capacity of the heat exchanger may, for example, be significantly increased (e.g., increased by approximately 10-40%) when using the same inlet water temperature. For example, a 40 kW heat exchanger may exhibit approximately 8.8-11.2 kW of cooling capacity at an inlet water temperature of 84.2 deg F. while maintaining a cold air supply temperature within an equipment rack at 32 deg C. when utilized with a substantially zero-bypass, pressurized air flow system using. Alternately, for example, a 40 kW heat exchanger may exhibit 17.6-22.4 kW of cooling capacity at an inlet water temperature of 84.2 deg F. if the cold air supply temperature within an equipment rack is allowed to increase to 35 deg C. when utilized with a substantially zero-bypass, pressurized air flow system.

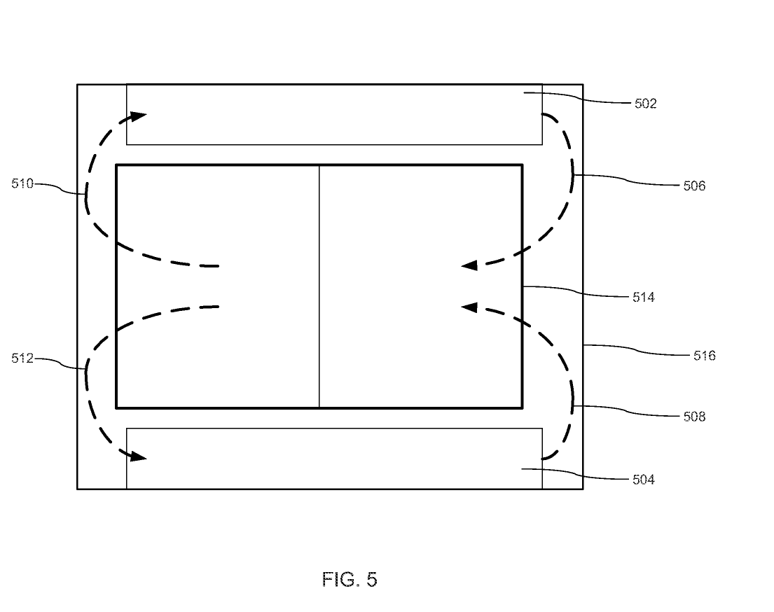

Turning to FIG. 5, a plan view of equipment rack 516 that includes dual heat exchangers 502 and 504 is exemplified. Heat exchangers 502 and 504 may, for example, include variable speed fans (not shown) that may generate air flows 506/510 and 508/512, respectively. Air flows 510/512 may, for example, exemplify heated air flows that may have absorbed heat from electrical components 514 that may be operating within the equipment rack of FIG. 5. Air flows 506/508 may, for example, exemplify cooled air flows that may have been cooled by heat exchangers 502 and 504, respectively.

A controller (not shown) may interoperate with a pressure sensor (not shown) to maintain cooled air flows 506 and 508 at a higher pressure than heated air flows 510 and 512. Accordingly, for example, an ample cool air supply may be provided to electrical components 514 that may receive cooled air flows 506 and 508. As a need for a volume of cooled air increases (e.g., as may be necessitated by a decrease in a cooling capacity of heat exchangers 502 and/or 504), a controller (not shown) may increase an air speed of one or more fans (not shown) within heat exchangers 502 and/or 504. A pressure sensor (not shown) may verify the increased cool air volume by measuring an increased pressure differential between the cool air supply and the heated air exhaust and may report same to the controller (not shown).

It is noted that a single heat exchanger may be used to supply the requisite amount of cooled air within the equipment rack of FIG. 5. Alternately, heat exchangers 502 and 504 may be sized to supply the requisite amount of cooled air within the equipment rack of FIG. 5 and may operate in a dual-redundancy mode. For example, heat exchangers 502 and 504 may operate at half capacity (e.g., by adjusting the inlet water temperature of heat exchangers 502 and/or 504 or by adjusting a volume of cooled air generated by heat exchangers 502 and/or 504) and may interoperate to provide all of the cooled air flow that may be required. If a failure occurs within one of heat exchangers 502 or 504, then a cooling capacity of the operational heat exchanger may be increased (e.g., by decreasing the inlet water temperature into the operational heat exchanger or by increasing the volume of air flow generated by the operational heat exchanger) to meet the increased cooled air demand caused by the failed heat exchanger.

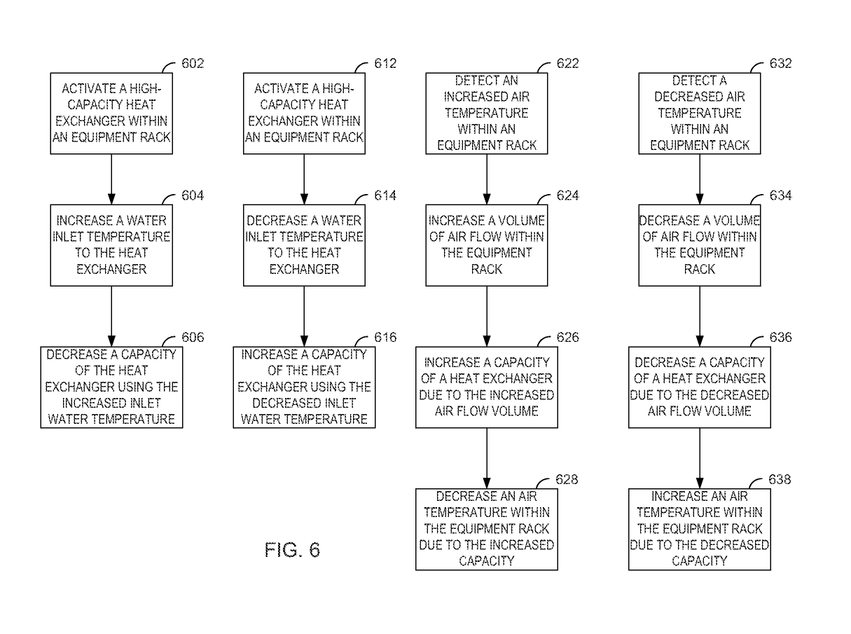

Turning to FIG. 6, process flows are exemplified. In step 602, a high-efficiency heat exchanger may be activated within an equipment rack to cool electrical equipment that may be operating within the equipment rack. In step 604, a temperature of inlet water to the heat exchanger may be increased to decrease a capacity of the heat exchanger (e.g., below half of a maximum capacity of the heat exchanger). In step 612, a high-efficiency heat exchanger may be activated within an equipment rack to cool electrical equipment that may be operating within the equipment rack. In step 614, a temperature of inlet water to the heat exchanger may be decreased to increase a capacity of the heat exchanger. Accordingly, for example, a sensor may be used to determine a water inlet temperature flowing into a heat exchanger. In so doing, the inlet water temperature may be selected such that a cooling capacity of the heat exchanger may be controlled to be within an adjustable range (e.g., between one-third and two-thirds of the maximum cooling capacity of the heat exchanger).

In step 622, an increased air temperature within an equipment rack may be detected. In step 624, a volume of air circulating within the equipment rack may be increased (e.g., a speed of one or more variable-speed fans of the heat exchanger may be increased while maintaining the same inlet water temperature to the heat exchanger), which may then increase a cooling capacity of the heat exchanger (e.g., as in step 626). In so doing, an air temperature within the equipment rack may be decreased (e.g., as in step 628). In step 632, a decreased air temperature within an equipment rack may be detected. In step 634, a volume of air circulating within the equipment rack may be decreased (e.g., a speed of one or more variable-speed fans of the heat exchanger may be decreased while maintaining the same inlet water temperature to the heat exchanger), which may then decrease a cooling capacity of the heat exchanger (e.g., as in step 636). In so doing, an air temperature within the equipment rack may be increased (e.g., as in step 638).

Accordingly, for example, capacities of heat exchangers may be adjusted by controlling a volume of air that may be generated by variable-speed fans implemented within the heat exchanger(s) instead of adjusting a temperature of inlet water flowing into the heat exchanger(s). In so doing, for example, less energy may be expended when adjusting heat exchanger cooling capacities of a cooling system, which may further increase the PUE of such a cooling system.

Other aspects and embodiments of the present invention will be apparent to those skilled in the art from consideration of the specification and practice of the invention disclosed herein. For example, heat exchangers utilizing liquids other than water (e.g., refrigerant based liquids, alcohol based solutions, glycol solutions, or water-based solutions) may instead by utilized. In addition, variable-speed fans may not necessarily be implemented within the heat exchangers, but may instead be implemented anywhere within the equipment rack to control air flow within the equipment rack. It is intended, therefore, that the specification and illustrated embodiments be considered as examples only, with a true scope and spirit of the invention being indicated by the following claims.

What is claimed is:

1. A close-coupled cooling system, comprising:
an equipment rack including a heat exchanger; and
a water supply to provide water into the heat exchanger, wherein a temperature of the water is adjusted to reduce a cooling capacity of the heat exchanger.

2. The cooling system of claim 1, wherein the cooling capacity is adjusted to less than half a maximum cooling capacity of the heat exchanger.

3. The cooling system of claim 1, further comprising variable-speed fans.

4. The cooling system of claim 1, further comprising:
variable-speed fans; and
a pressure sensor, wherein a speed of the variable-speed fans is selected based on a signal from the pressure sensor.

5. The cooling system of claim 1, further comprising:
variable-speed fans; and
a pressure sensor, wherein a speed of the variable-speed fans is increased based on a low-pressure signal from the pressure sensor.

6. The cooling system of claim 1, further comprising:
variable-speed fans; and
a pressure sensor, wherein a speed of the variable-speed fans is decreased based on a high-pressure signal from the pressure sensor.

7. The cooling system of claim 1, further comprising:
a second heat exchanger included within the equipment rack; and
a second water supply to supply water to the second heat exchanger, wherein a temperature of the water supplied by the second water supply is adjusted to reduce a cooling capacity of the second heat exchanger.

8. A cooling system comprising:
an equipment rack;
a heat exchanger included within the equipment rack; and
a controller, wherein the controller selects a temperature of water flow into the heat exchanger to adjust a cooling capacity of the heat exchanger that is below a maximum cooling capacity of the heat exchanger.

9. The cooling system of claim 8, wherein the cooling capacity of the heat exchanger is adjusted to below one half of the maximum cooling capacity of the heat exchanger by increasing the temperature of the water flow.

10. The cooling system of claim 8, wherein the cooling capacity of the heat exchanger is adjusted to approximately one third of the maximum cooling capacity of the heat exchanger by increasing the temperature of the water flow.

11. The cooling system of claim 8, further comprising a heat rejection source to cool exhaust water from the heat exchanger.

12. The cooling system of claim 8, further comprising a heat rejection source to cool exhaust water from the heat exchanger, wherein the cooled exhaust water is blended with the exhaust water from the heat exchanger to increase a temperature of the water flow into the heat exchanger.

13. The cooling system of claim 8, further comprising:
a heat rejection source to cool exhaust water from the heat exchanger; and
a chiller, wherein the cooled exhaust water is blended with chilled water from the chiller to decrease a temperature of the water flow into the heat exchanger.

14. A method comprising:
selecting a desired cooling capacity of a heat exchanger;
selecting a water inlet temperature to the heat exchanger; and
adjusting a cooling capacity of the heat exchanger to the desired cooling capacity in response to the selected water inlet temperature.

15. The method of claim 14, wherein the adjusted cooling capacity is less than half of a maximum cooling capacity of the heat exchanger.

16. The method of claim 14, wherein the adjusted cooling capacity is increased by increasing a volume of air flow produced by the heat exchanger.

17. The method of claim 14, wherein the adjusted cooling capacity is decreased by decreasing a volume of air flow produced by the heat exchanger.

18. The method of claim 14, wherein selecting a water inlet temperature comprises blending exhaust water from the heat exchanger with cooled water to increase the inlet water temperature.

19. The method of claim 14, wherein selecting a water inlet temperature comprises cooling exhaust water from the heat exchanger by evaporation.

20. The method of claim 14, wherein selecting a water inlet temperature comprises cooling exhaust water from the heat exchanger by radiation.
